(19) United States
(12) Patent Application Publication
(10) Pub. No.: US 2025/0207668 A1
(43) Pub. Date: Jun. 26, 2025

(54) FIRE-RESISTANT GLOBE VALVE

(71) Applicant: Engineered Controls International, LLC, Elon, NC (US)

(72) Inventors: Christopher Taylor Herman, Greensboro, NC (US); James Pardue, Greensboro, NC (US); Tracy Tickle, Gibsonville, NC (US)

(21) Appl. No.: 18/988,217

(22) Filed: Dec. 19, 2024

Related U.S. Application Data
(60) Provisional application No. 63/614,155, filed on Dec. 22, 2023.

(51) Int. Cl. F16K 1/04; F16K 1/08

(52) U.S. Cl. CPC F16K 1/04; F16K 1/08

(57) ABSTRACT

A fire-resistant globe valve includes a valve body defining an inlet, an outlet, and a flow path. The globe valve includes a valve seat located along the flow path between the inlet and the outlet, a stem including a first end and a second end, and a plug coupled to the second end of the stem. The plug includes a plug body and a seat disc. The seat disc is coupled to the plug body. The seat disc is configured to sealingly engage the valve seat in a first closed position. The globe valve includes one or more springs positioned between and engaging the second end of the stem and the plug body. The one or more springs are configured to bias the plug body to sealingly engage the valve seat in a second closed position when the seat disc deforms from exposure to fire conditions.

### CROSS-REFERENCE TO RELATED APPLICATION

This application claims the benefit of U.S. Provisional Patent Application No. 63/614,155, filed on Dec. 22, 2023, which is incorporated herein by reference in its entirety.

### TECHNICAL FIELD

This disclosure generally relates to globe valves and, more particularly, to fire-resistant globe valves.

### BACKGROUND

Pressurized fluid receptacles (e.g., tanks or cylinders) may be used to supply or otherwise generate a flow of pressurized fluid or pressurized gas through a pressurized fluid conduit. In some instances, a shut-off valve is implemented to divert or close off the flow of the pressurized fluid from the pressurized fluid receptacle. Closing off or diverting the fluid flow from the pressurized fluid receptacle is desirable to control transport of the pressurized fluid to a desired location. For instance, a shut-off valve may cut off or divert the flow of the pressurized fluid when a problem is detected or pressurized fluid demand changes.

Some pressurized fluid receptacles are designed to hold cryogenic fluids, such as liquefied hydrogen (LH2), liquified helium, liquefied carbon dioxide (CO2), liquefied nitrogen, liquefied natural gas, and other such gases and fluids. In such instances, a cryogenic shut-off valve may be connected to and in fluid communication with the pressurized fluid receptacle to divert or close off the flow of the cryogenic fluid. The cryogenic shut-off valve is able to withstand the extreme operating conditions associated with cryogenic fluid handling to reliably cut off or divert the pressurized fluid flow as needed.

Occasionally, a cryogenic shut-off valve may also be exposed to extremely hot conditions, such as when the cryogenic shut-off valve is exposed to a fire. Such conditions may deter some cryogenic shut-off valves from consistently diverting or otherwise closing off the flow of the cryogenic fluid from the pressurized fluid receptacle.

### SUMMARY

An example fire-resistant globe valve includes a valve body defining an inlet, an outlet, and a flow path extending between the inlet and the outlet. The fire-resistant globe valve includes a valve seat located along the flow path between the inlet and the outlet, a stem including a first end and a second end, and a plug coupled to the second end of the stem. The plug includes a plug body and a seat disc. The seat disc is coupled to the plug body. The seat disc is configured to sealingly engage the valve seat in a first closed position of the plug. The fire-resistant globe valve includes one or more springs positioned between and engaging the second end of the stem and the plug body. The one or more springs are configured to bias the plug body to sealingly engage the valve seat in a second closed position of the plug when the seat disc deforms from exposure to fire conditions.

Another example fire-resistant globe valve includes a valve seat, a stem, and a plug coupled to the stem. The plug includes a plug body and a seat disc. The seat disc is coupled to the plug body. The seat disc is configured to sealingly engage the valve seat in a first closed position of the plug. The fire-resistant globe valve includes one or more springs positioned between and engaging the stem and the plug body. The one or more springs are configured to bias the plug body to sealingly engage the valve seat in a second closed position of the plug when the seat disc deforms from exposure to fire conditions.

### BRIEF DESCRIPTION OF THE DRAWINGS

FIG. 1 is a cross-sectional view of a known globe valve for cryogenic fluid.

FIG. 2 is an expanded cross-sectional view of a portion of the globe valve of FIG. 1.

FIG. 3 is another expanded cross-sectional view of a portion of the globe valve of FIG. 1.

FIG. 4 illustrates an example fire-resistant globe valve for cryogenic fluid in accordance with the teachings herein.

FIG. 5 is a cross-sectional view of the fire-resistant globe valve of FIG. 4.

FIG. 6 is a cross-sectional view of a plug of the fire-resistant globe valve of FIG. 4 in a first closed position.

FIG. 7 is an expanded cross-sectional view of a portion of the plug in the first closed position of FIG. 6.

FIG. 8 is a cross-sectional view of the plug of FIG. 6 in a second closed position.

FIG. 9 is an expanded cross-sectional view of a portion of the plug in the second closed position of FIG. 8.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the seat disclosed embodiments.

Globe valves disclosed herein are configured to consistently shut off flow of fluid flowing from a fluid receptacle, both in cryogenic conditions and in fire conditions. For example, the globe valves disclosed herein include cryogenic globe valves that are fire resistant.

An example fire-resistant globe valve includes a valve seat, a plug, and a stem. The plug is connected to an end of the stem and includes a seat disc and a plug body. The plug is configured to sealingly engage the valve seat to shut off the flow of cryogenic fluid through the globe valve, and the plug is configured to disengage from the valve seat to permit the cryogenic fluid to flow through the globe valve. The stem is configured to move the plug to an open position at which the plug is disengaged from the valve seat. The stem also is configured to move the plug to a first closed position (also referred to as a “primary closed position”) at which the seat disc of the plug sealingly engages the valve seat. The valve seat may be formed of a metallic material, such as stainless steel, and the seat disc may be formed of a thermoplastic material, such as polytetrafluoroethylene, to enable the seat disc to consistently form a thermoplastic-to-metal sealed connection with the valve seat. In some instances, exposure to the fire conditions (e.g., exposure to temperatures between 750° C. and 1000° C. for a period of at least 30 minutes) may cause the seat disc formed of a thermoplastic material to melt away and/or otherwise become deformed.

The example fire-resistant globe valve also includes one or more springs that enable the plug body of the plug to sealingly engage the valve seat if the seat disc has become deformed when exposed to fire conditions (e.g., temperatures of between 750° C. and 1000° C.). The spring(s) are positioned between and engage the end of the stem and the plug body. The spring(s) may be preloaded disc springs, such as Belleville conical washers or disc springs. The spring(s) may engage each other, with a first spring also engaging the end of the stem and a second spring also engaging the plug body. If the seat disc has become deformed, the seat disc may no longer be able to sealingly engage the valve seat when the stem has positioned the plug in the first closed position. The spring(s) are configured to bias the plug body to sealingly engage the valve seat in a second closed position (also referred to as a “firesafe closed position”) in such instances. The plug body may be formed of a metallic material, such as stainless steel, to enable the plug body to at least temporarily form a metal-to-metal sealed connection with the valve seat until the fire conditions cease and the seat disc can be repaired and/or replaced.

For example, the valve seat includes an upper surface and angled surface that extends inwardly and downwardly from the upper surface. Additionally, the plug body includes an outer rim that extends in a downward direction and defines a groove. When coupled to the plug body, the seat disc is received in the groove such that a portion of the seat disc extends beyond a lower end of the rim. When the plug is in the first closed position, (1) the seat disc engages the angled surface of the valve seat and (2) a gap is formed between the lower end of the outer rim of the plug body and the upper surface of the valve seat. When the seat disc has been deformed due to fire conditions, a biasing force of the spring(s) pushes the plug body to close the gap and cause the lower end of the outer rim of the plug body to engage the upper surface of the valve seat in the second closed position. That is, when the seat disc becomes deformed, the spring(s) bias the plug body to transition the plug from the first closed position to the second closed position without (1) requiring further actuation of the stem (e.g., by an operator) and (2) relying on backpressure to close the flow path.

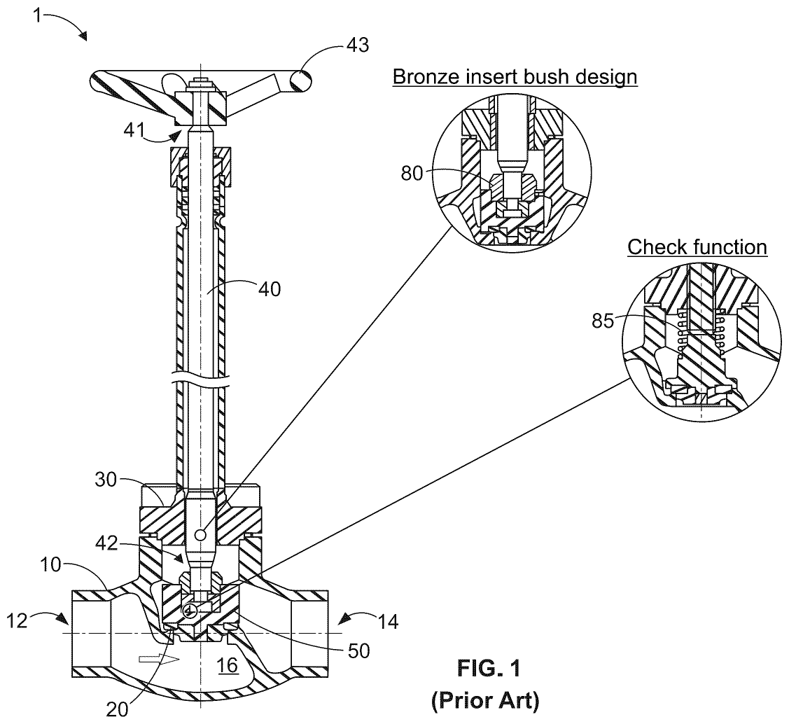

Turning to the figures, FIGS. 1-3 illustrates a previously-known design of globe valve 1. As shown in FIG. 1, body 10 defines inlet 12, outlet 14, and flow path 16 that extends between inlet 12 and outlet 14. Valve seat 20 is located along flow path 16. Bonnet 30 is coupled to body 10, and stem 40 extends through bonnet 30. Stem 40 includes upper end 41 and lower end 42. Wheel 43 is coupled to upper end 41 of stem 40, and plug 50 is coupled to lower end 42 of stem 40. An operator may rotate wheel 43 in a first direction to cause stem 40 to move in a downward direction and, in turn, cause plug 50 to engage valve seat 20. The operator may rotate wheel 43 in a second opposing direction to cause stem 40 to move in an upward direction and, in turn, cause plug 50 to disengage valve seat 20.

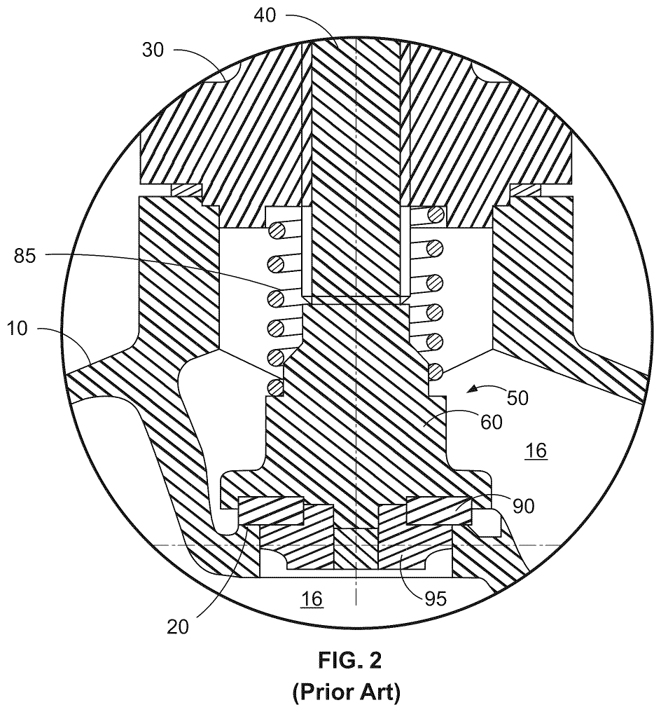

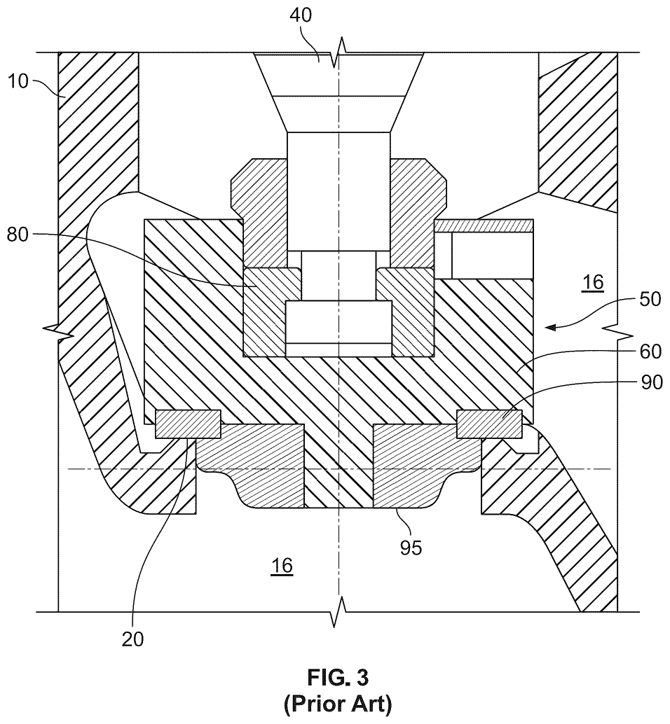

FIGS. 2-3 further depict plug 50 of the previously-known design of globe valve 1. As shown in FIG. 3, bronze insert bushing 80 is positioned adjacent lower end 42 of stem 40 for the connection between stem 40 and plug 50. As shown in FIGS. 2-3, plug 50 includes plug body 60, seat disc 90, and disc cap 95. Seat disc 90 of plug 50 engages valve seat 20 to divert or close off the flow of fluid through flow path 16 of body 10. As shown in FIG. 2, globe valve 1 includes an optional check spring 85 that extends between and engages bonnet 30 and plug body 60 of plug 50.

Check spring 85 is configured to create a check function that (i) permits fluid to flow through flow path 16 in a forward direction from inlet 12 to outlet 14 and (ii) prevents backflow of the fluid from outlet 14 and toward inlet 12. Check spring 85 is configured to bias plug 50 in a downward direction toward valve seat 20. However, check spring 85 is undersized such that its biasing force is relatively small. When pressurized fluid flows into flow path 16 through inlet 12, the pressurized fluid pushes upward on plug 50 with a force that overcomes the downward biasing force of check spring 85. In turn, seat disc 90 of plug 50 disengages from valve seat 20 to permit the pressurized fluid to flow to and through outlet 14 of flow path 16. In contrast, when no fluid is flowing through flow path 16 and/or when fluid is flowing in a backward direction into flow path 16 via outlet 14, the downward biasing force of check spring 85 is not overcome by any upward force acting on plug 50. In turn, seat disc 90 of plug 50 engages valve seat 20, even though stem 40 has moved plug 50 to an open position, to prevent backflow of the fluid through flow path 16.

Globe valve 1 may be exposed to fire conditions. In such instances, seat disc 90 may melt away and/or otherwise become deformed that prevents seat disc 90 from engaging valve seat 20 when stem 40 has positioned plug 50 in a closed position. In turn, a gap forms between plug 50 and valve seat 20 that permits fluid to flow through flow path, even when stem 40 has positioned plug 50 in the closed position. While check spring 85 provides a downward biasing force, check spring 85 is undersized and unable to push plug 50 further downward to close flow path 16 when any forward flow with upstream pressure of fluid is present and pushing upward on plug 50. In turn, check spring 85 is unable to close globe valve 1 when seat disc 90 has become damaged due to exposure to fire conditions.

In some instances, a backpressure may be present when globe valve 1 is exposed to fire condition. The backpressure may push plug 50 further downward to cause plug body 60 to temporarily engage valve seat 20 and, in turn, close flow path 16 during the fire conditions. However, a backpressure may not always be present during fire conditions to close flow path 16. Further, even when a backpressure is present during fire conditions, it may not be sufficient to consistently cause plug 50 to close flow path 16. Thus, there remains a need to have a force that consistently closes a plug of a globe valve during fire conditions without interfering with other functions of the globe valve.

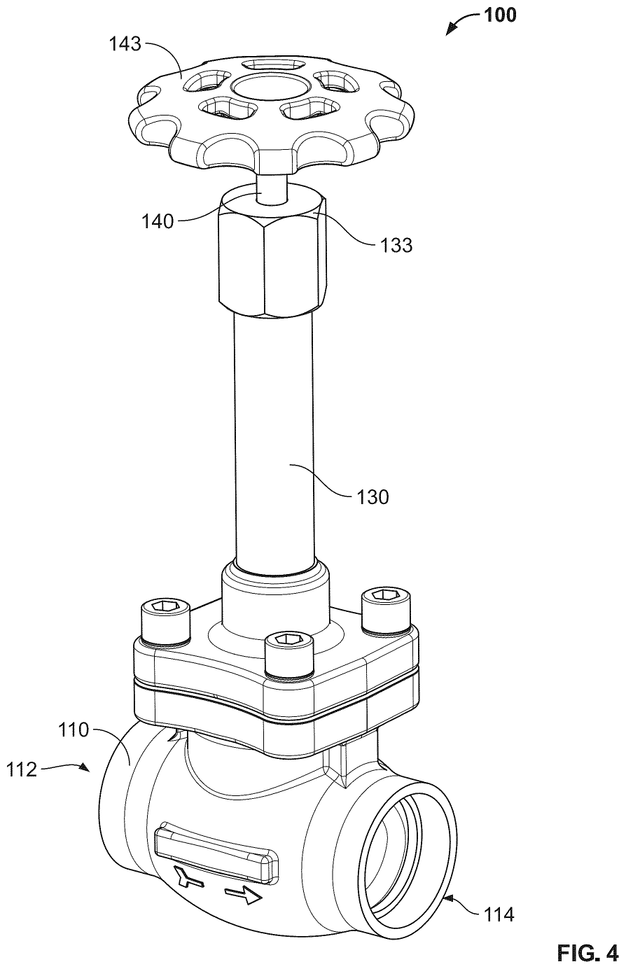

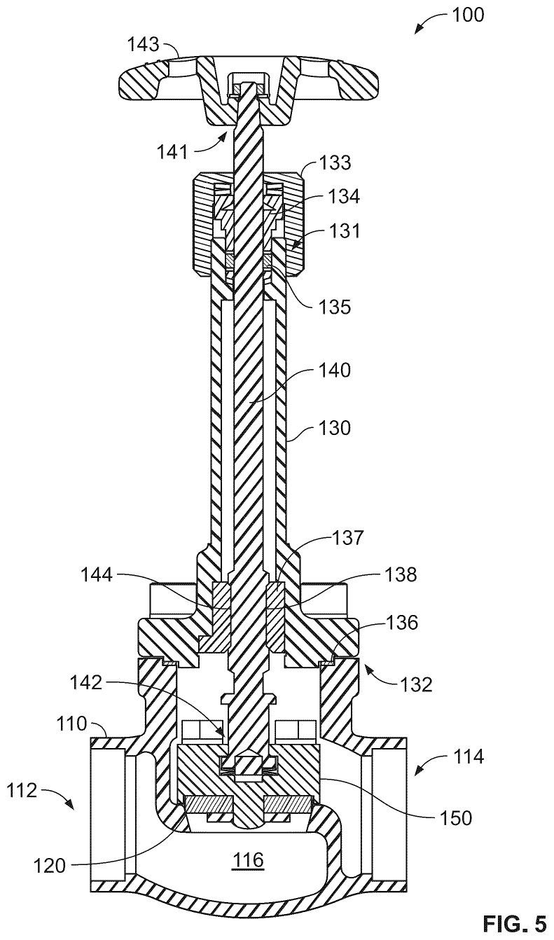

Turning to FIGS. 4-9, an example globe valve 100 (also referred to as a “fire-resistant globe valve”) is depicted in accordance with the teachings herein. As shown in FIGS. 4-5, globe valve 100 includes valve body 110 and bonnet 130. Valve body 110 and bonnet 130 are formed of a material, such as austenitic stainless steel, that is capable of withstanding extreme operating temperatures of cryogenic fluids (e.g., −270° C. to +85° C.). In the illustrated example, valve body 110 and bonnet 130 are securely coupled together via welding and/or other means. In other examples, valve body 110 and bonnet 130 are integrally formed together as a single body.

As shown in FIG. 5, valve body 110 defines inlet 112, outlet 114, and flow path 116. Flow path extends between inlet 112 and outlet 114. Globe valve 100 includes valve seat 120 that is located along flow path 116 between inlet 112 and outlet 114. In the illustrated example, valve body 110 includes and is integrally and monolithically formed with valve seat 120. In other examples, valve seat 120 is formed separately from and is securely coupled to valve body 110.

Bonnet 130 includes upper bonnet end 131 (also referred to as “first bonnet end”) and lower bonnet end 132 (also referred to as “second bonnet end”). Lower bonnet end 132 is securely coupled to valve body 110. In the illustrated example, globe valve 100 includes seal 136 that sealingly engages valve body 110 and lower bonnet end 132 to form a sealed connection between valve body 110 and bonnet 130. Cover 133 of globe valve 100 is securely coupled to upper bonnet end 131 of bonnet 130.

Globe valve 100 also includes stem 140 that extends through bonnet 130. Stem 140 includes upper stem end 141 (also referred to as “first stem end” and “first end”) and lower stem end 142 (also referred to as “second stem end” and “second end”). As disclosed below in greater detail, plug 150 of globe valve 100 is coupled to lower stem end 142 of stem 140. Plug 150 is configured to sealingly engage valve seat 120 in a closed position, such as a primary closed position and/or a firesafe closed position, to stop fluid (e.g., cryogenic fluid) from flowing through flow path 116 of globe valve 100. Plug 150 is configured to be disengaged from valve seat 120 in an open position to permit fluid to flow through flow path 116 of globe valve 100.

As shown in FIGS. 4-5, globe valve 100 includes actuator 143 that is coupled to upper stem end 141 of stem 140. In the illustrated example, actuator 143 is a wheel, such as a crank wheel. In other examples, actuator 143 may be any other type of rotating handle that enables an operator to manually rotate stem 140 to control operation of globe valve 100.

As shown in FIG. 5, bonnet 130 includes inner threads 138 and stem 140 includes outer threads 144. In the illustrated example, bonnet 130 includes threaded insert 137 that defines inner threads 138 of bonnet 130. Inner threads 138 and outer threads 144 threadably engage each other to cause stem 140 to move upward and/or downward as stem 140 is rotated clockwise and/or counterclockwise via actuator 143. That is, outer threads 144 of stem 140 threadably engage inner threads 138 of bonnet 130 to convert rotational movement of stem 140 into vertical movement of stem 140 and, in turn, plug 150. For example, an operator may rotate stem 140, via actuator 143, in a first direction to cause plug 150 to move in a downward direction toward valve seat 120 to close globe valve 100. In contrast, the operator may rotate stem 140, via actuator 143, in a second direction to cause stem 140 and plug 150 to move in an upward direction away from valve seat 120 to open globe valve 100. That is, actuator 143 is configured to actuate plug between an open position and a closed position (e.g., a first closed position and/or a second closed position).

In the illustrated example, globe valve 100 also includes packing 134 and seal 135 to form a sealed connection between stem 140 and bonnet 130. For example, packing 134 and seal 135 are positioned circumferentially between stem 140 and bonnet 130 to form a sealed connection between stem 140 and bonnet 130. Seal 135 is positioned circumferentially between and sealingly engages stem 140 and bonnet 130 adjacent upper bonnet end 131 of bonnet 130. Packing 134 is positioned adjacent upper bonnet end 131 and is enclosed by bonnet 130 and cover 133.

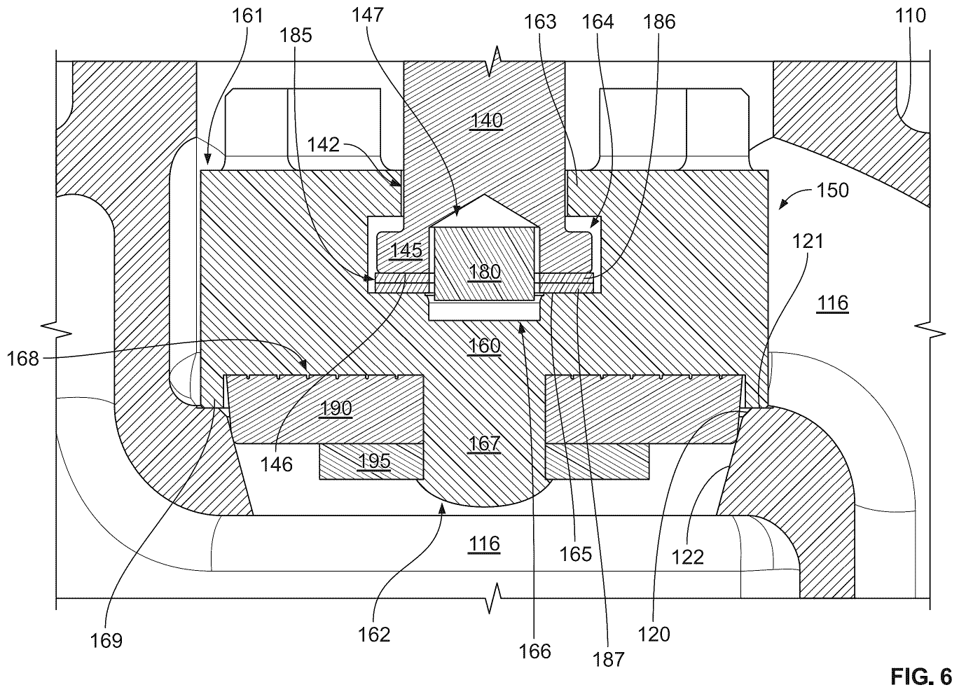

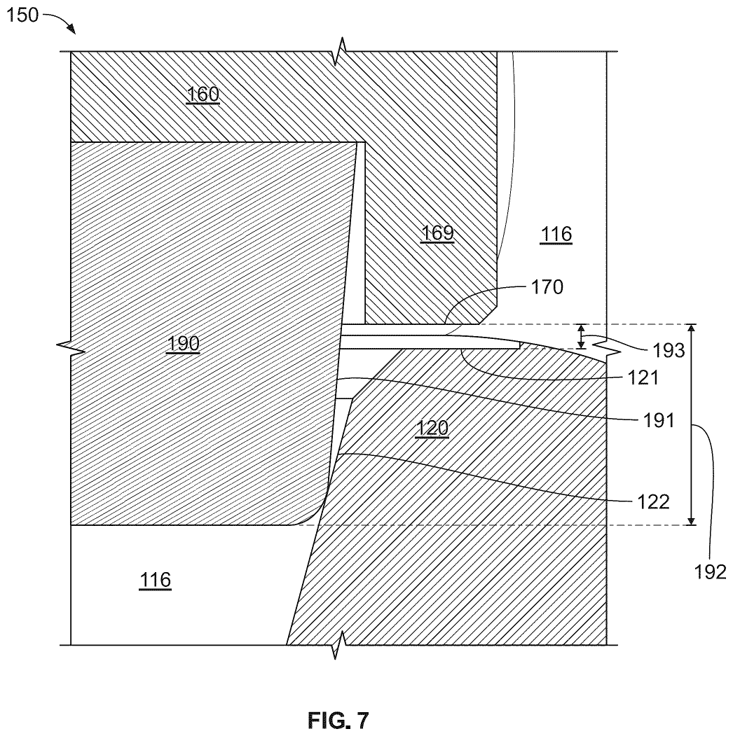

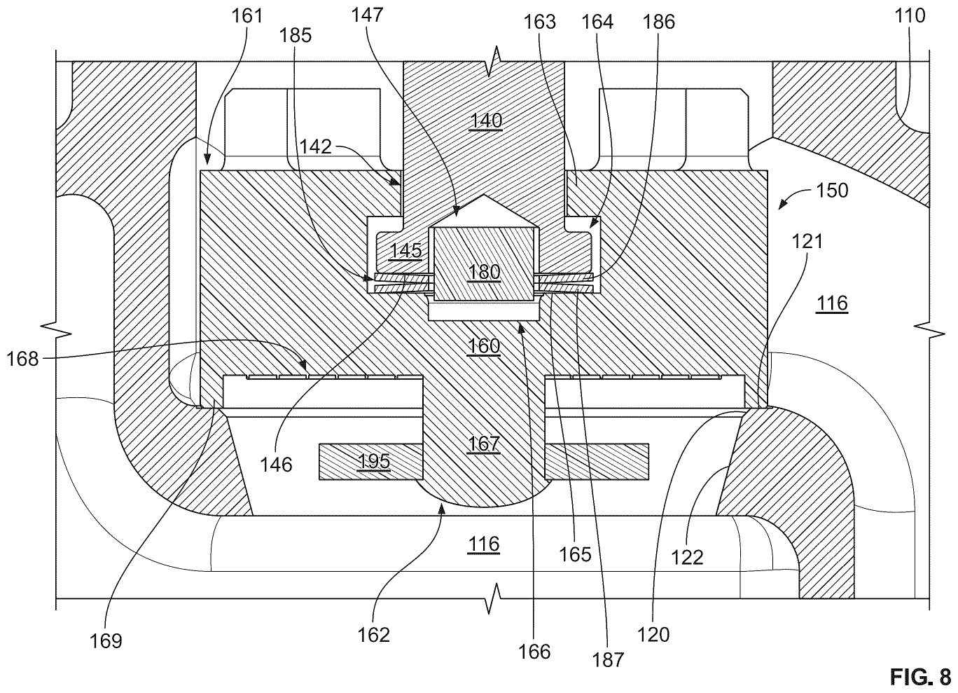

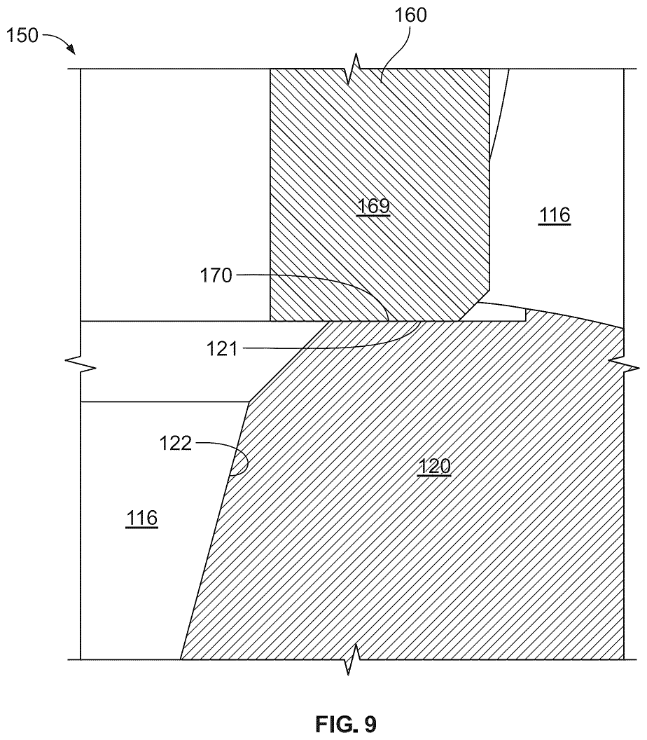

Globe valve 100 of the illustrated example includes a first closed position and a second closed position for fire-resistance purposes. In a first closed position (also referred to as a “primary closed position”) shown in FIGS. 6-7, seat disc 190 of plug 150 is configured to sealingly engage valve seat 120. When exposed to fire conditions for an extended period of time (e.g., when exposed to temperatures between 750° C. and 1000° C. for a period of at least 30 minutes), seat disc 190 may melt away and/or otherwise become deformed. In such instances as shown in FIGS. 8-9, plug body 160 of plug 150 is configured to sealingly engage valve seat 120 in a second closed position (also referred to as a “firesafe closed position”) to close globe valve 100.

As shown in FIGS. 6 and 8, plug 150 includes plug body 160. In the illustrated example, plug body 160 includes upper plug end 161 (also referred to as “first plug end”) and lower plug end 162 (also referred to as “second plug end”). Plug body 160 includes inner surface 165 that defines cavity 164. Cavity 164 is formed by plug body 160 to have a cavity inlet along upper plug end 161. In the illustrated example, cavity 164 extends vertically along a center axis of plug 150. Plug body 160 further includes lip 163 that extends radially inward at the cavity inlet of cavity 164.

Cavity 164 of plug body 160 is configured to securely receive lower stem end 142 of stem 140 to couple plug 150 to stem 140. That is, lower stem end 142 of stem 140 extends into and is received by cavity 164 of plug body 160. In the illustrated example, stem 140 includes flange 145 that extends radially outward at lower stem end 142. Lip 163 of plug body 160 is configured to overlap flange 145 of stem 140 to securely connect plug 150 to lower stem end 142 of stem 140.

Globe valve 100 also includes one or more springs 185 that are positioned between and engage lower stem end 142 of stem 140 and plug body 160. For example, springs 185 are positioned between and engage lower end surface 146 of stem 140 at lower stem end 142 and a portion of inner surface 165 of plug body 160 within cavity 164 of plug body 160. As disclosed below in greater detail, springs 185 are configured to bias plug body 160 to sealingly engage valve seat 120 in the second closed position when seat disc 190 has melted away and/or has otherwise deformed due to exposure to fire conditions (e.g., temperatures of between 750° C. and 1000° C.).

In the illustrated example, each spring 185 is a preloaded disc spring, such as a Belleville conical washer or disc spring. Springs include first spring 186 (also referred to as an “upper spring”) and second spring 187 (also referred to as a “lower spring”). Springs 186, 187 are in a mirrored orientation with respect to each other to prevent one spring 186, 187 from becoming nested within the other spring 186, 187. Springs 186, 187 engage each other. Additionally, first spring 186 engages lower end surface 146 at lower stem end 142 of stem 140, and second spring 187 engages inner surface 165 of plug body 160.

Globe valve 100 also includes insert 180 to retain springs 185 in place between lower stem end 142 of stem 140 and inner surface 165 of plug body 160. For example, a first end of insert 180 is coupled to lower stem end 142 of stem 140 and a second opposing end of insert 180 is slidably received by recess 166 of plug body 160. Lower end surface 146 of stem 140 defines hole 147 (e.g., a blind hole) that securely receives a portion of an upper end of insert 180 to couple insert 180 to lower stem end 142 of stem 140. Inner surface 165 of plug body 160 defines recess 166 that is configured to slidably receive at least a portion of a lower end of insert 180. Insert 180 extends through springs 185 between lower stem end 142 of stem 140 and recess 166 of plug body 160 to retain springs 185 in place.

As shown in FIGS. 6 and 8, plug body 160 includes shaft 167 that extends in a downward direction to lower plug end 162. In the illustrated example, plug body 160 also includes outer rim 169 that extends in a downward direction toward lower plug end 162. Outer rim 169 is located along an outer circumferential surface and extends circumferentially about an upper portion of shaft 167. Outer rim 169 and shaft 167 define groove 168 of plug body 160. That is, outer rim 169 at least partially defines groove 168. In the illustrated example, groove 168 is disc shaped. Outer rim 169 and shaft 167 are spaced apart radially from each other such that an inner surface of outer rim 169 defines an outer portion of groove 168 and an outer surface of shaft 167 defines an inner portion of groove 168.

Plug 150 includes seat disc 190 that is coupled to plug body 160. Seat disc 190 is received by groove 168 to couple seat disc 190 to plug body 160. In the illustrated example, a portion of seat disc 190 extends beyond lower end 170 of outer rim 169 (FIGS. 7 and 9) when seat disc is received by groove 168. Plug 150 further includes disc cap 195 that is securely coupled to a distal end of shaft 167 to retain seat disc 190 about shaft 167 and in groove 168.

FIGS. 6-7 further depict plug 150 in the first closed position at which seat disc 190 is configured to sealingly engage valve seat 120. The operator is to rotate stem 140 to a corresponding position to position plug in its first closed position. To consistently form a sealed connection between seat disc 190 and valve seat 120 in the first closed position, valve seat 120 is composed of a metallic material and seat disc 190 is composed of a thermoplastic material. For example, valve seat 120 is composed of a metallic material, such as stainless steel (e.g., austenitic stainless steel), that is capable of withstanding extreme operating temperatures of cryogenic fluids (e.g., −270° C. to +85° C.). Seat disc 190 is composed of a thermoplastic material (e.g., polytetrafluoroethylene (PTFE), such as XP-267 PTFE) and/or any other material that is able to consistently form a sealed connection with valve seat 120. That is, valve seat 120 is composed of a metallic material and seat disc 190 is composed of a thermoplastic material such that a thermoplastic-to-metal seal is formed when seat disc 190 engages valve seat 120 in the first closed position.

As shown in FIG. 7, valve seat 120 includes upper surface 121 and angled surface 122. Upper surface 121 extends horizontally and is parallel to lower end 170 of outer rim 169 of plug body 160. Angled surface 122 extends away from outer rim 169 of plug body 160. For example, angled surface 122 extends downwardly and inwardly from an inner edge of upper surface 121.

Seat disc 190 is configured to engage angled surface 122 of valve seat 120 when plug 150 is in the first closed position. Seat disc 190 extends downwardly beyond lower end 170 of outer rim 169 by distance 192 to enable seat disc 190 to engage a portion of angled surface 122 below upper surface 121 of valve seat. In the illustrated example, seat disc 190 has a truncated cone shape to further facilitate seat disc 190 in engaging angled surface 122 of valve seat 120. For example, seat disc 190 includes outer circumferential surface 191 that angles inward as it extends downward to facilitate outer circumferential surface 191 in engaging angled surface 122 of valve seat 120.

As shown in FIG. 7, gap 193 is formed between upper surface 121 of valve seat 120 and lower end 170 of outer rim 169 of plug body 160 when seat disc 190 sealingly engages angled surface 122 of valve seat 120 in the first closed position of plug 150. Gap 193 is relatively small (e.g., about 0.020 inches). When seat disc 190 has melted away and/or otherwise become damaged when exposed to fire conditions, the biasing force provided by springs 185 (FIGS. 6 and 8) is configured to close gap 193 and transition plug 150 to the second closed position without (1) further actuation from stem 140 and (2) relying on backpressure to close flow path 116.

FIG. 8 depict plug 150 in the second closed position when seat disc 190 has melted away and/or otherwise become decoupled from plug body 160 of plug 150. Returning briefly to FIG. 6, springs 185 are in a compressed state between stem 140 and plug body 160 when plug is in the first closed position. As shown in FIG. 8, springs 185 are in an expanded state between stem 140 and plug body 160 when plug is in the second closed position. When seat disc 190 is no longer coupled to plug body 160, seat disc 190 does not sealingly engage angled surface 122 of valve seat 120. In turn, springs 185 are able to expand and push plug body 160 downward as stem 140 remains unmoved. The biasing force of springs 185 pushes plug body 160 downward until lower end 170 of outer rim 169 of plug body 160 engages upper surface 121 of valve seat 120. FIG. 9 further depicts lower end 170 of outer rim 169 engaging upper surface 121 of valve seat 120, with gap 193 (FIG. 7) no longer present, in the second closed position of plug 150.

For example, valve seat 120 is composed of a metallic material, such as stainless steel (e.g., austenitic stainless steel, such as 304 stainless steel), that is capable of withstanding extreme operating temperatures of cryogenic fluids (e.g., −270° C. to +85° C.). Plug body 160 is also composed of a metallic material, such as stainless steel (e.g., austenitic stainless steel, such as 304 stainless steel), that is capable of withstanding extreme operating temperatures of cryogenic fluids. In turn, in the second closed position of plug 150, a metal-to-metal seal is at least temporarily formed between plug body 160 and valve seat 120 to close flow path 116 of globe valve 100, even with upstream pressure of fluid, until the fire conditions end and a replacement seat disc can subsequently be inserted in place.

Exemplary embodiments in accordance with the teachings herein are disclosed below.
Embodiment 1. A fire-resistant globe valve includes a valve body defining an inlet, an outlet, and a flow path extending between the inlet and the outlet. The fire-resistant globe valve includes a valve seat located along the flow path between the inlet and the outlet, a stem including a first end and a second end, and a plug coupled to the second end of the stem. The plug includes a plug body and a seat disc. The seat disc is coupled to the plug body. The seat disc is configured to sealingly engage the valve seat in a first closed position of the plug. The fire-resistant globe valve includes one or more springs positioned between and engaging the second end of the stem and the plug body. The one or more springs are configured to bias the plug body to sealingly engage the valve seat in a second closed position of the plug when the seat disc deforms from exposure to fire conditions.
Embodiment 2. The fire-resistant globe valve of embodiment 1, wherein each of the one or more springs is a preloaded disc spring.
Embodiment 3. The fire-resistant globe valve of embodiment 1 or 2, wherein the one or more springs includes a first spring and a second spring. The first spring engages the second spring and the second end of the stem. The second spring engages the first spring and the plug body.
Embodiment 4. The fire-resistant globe valve of embodiment 3, wherein the first spring is in a mirrored orientation with respect to the second spring.
Embodiment 5. The fire-resistant globe valve of any of embodiments 1-4, wherein the plug body defines a cavity. The second end of the stem extends into the cavity. The one or more springs are located in the cavity.
Embodiment 6. The fire-resistant globe valve of embodiment 5, wherein the plug body includes an inner surface that defines the cavity. At least one of the one or more springs engages the inner surface of the plug body.
Embodiment 7. The fire-resistant globe valve of embodiment 6, further including an insert that is coupled to the second end of the stem. The inner surface of the plug body further defines a recess that at least partially receives the insert.
Embodiment 8. The fire-resistant globe valve of embodiment 7, wherein the insert extends through the one or more springs to retain the one or more springs in place between the second end of the stem and the inner surface of the plug body.
Embodiment 9. The fire-resistant globe valve of any of embodiments 5-8, wherein the stem includes a flange at the second end. The plug body includes a lip at a cavity inlet of the cavity. The lip of the plug body is configured to overlap the flange of the stem to connect the plug to the second end of the stem.
Embodiment 10. The fire-resistant globe valve of any of embodiments 1-9, wherein the valve seat is composed of metallic material and the seat disc is composed of thermoplastic material such that a thermoplastic-to-metal seal is formed when the seat disc engages the valve seat in the first closed position of the plug.
Embodiment 11. The fire-resistant globe valve of embodiment 10, wherein the plug body is composed of metallic material such that a metal-to-metal seal is formed when the plug body engages the valve seat in the second closed position of the plug.
Embodiment 12. The fire-resistant globe valve of any of embodiments 1-11, wherein the plug body includes an outer rim that at least partially defines a groove in which the seat disc is received. A portion of the seat disc extends beyond a lower end of the outer rim when the seat disc is received by the groove.
Embodiment 13. The fire-resistant globe valve of embodiment 12, wherein the valve seat includes an upper surface and angled surface that extends inwardly and downwardly from the upper surface.
Embodiment 14. The fire-resistant globe valve of embodiment 13, wherein the seat disc is configured to engage the angled surface of the valve seat in the first closed position of the plug. A gap is formed between the lower end of the outer rim of the plug body and the upper surface of the valve seat when the seat disc engages the angled surface in the first closed position of the plug.
Embodiment 15. The fire-resistant globe valve of embodiment 14, wherein, when the seat disc deforms while the plug is in the first closed position, a biasing force of the one or more springs is configured to cause the plug body to close the gap and transition the plug to the second closed position without backpressure and further actuation of the stem. The lower end of the outer rim is configured to engage the upper surface of the valve seat in the second closed position of the plug.
Embodiment 16. The fire-resistant globe valve of any of embodiments 1-15, further including a bonnet coupled to the valve body, wherein the stem extends through the bonnet.
Embodiment 17. The fire-resistant globe valve of any of embodiments 1-16, further including an actuator coupled to the first end of the stem to actuate the plug between the first closed position and an open position.
Embodiment 18. The fire-resistant globe valve of embodiment 17, wherein the actuator is a wheel.
Embodiment 19. A fire-resistant globe valve includes a valve seat, a stem, and a plug coupled to the stem. The plug includes a plug body and a seat disc. The seat disc is coupled to the plug body. The seat disc is configured to sealingly engage the valve seat in a first closed position of the plug. The fire-resistant globe valve includes one or more springs positioned between and engaging the stem and the plug body. The one or more springs are configured to bias the plug body to sealingly engage the valve seat in a second closed position of the plug when the seat disc deforms from exposure to fire conditions.
Embodiment 20. The fire-resistant globe valve of embodiment 19, wherein each of the one or more springs is a preloaded disc spring.
Embodiment 21. The fire-resistant globe valve of embodiment 19 or 20, wherein the one or more springs includes a first spring and a second spring. The first spring engages the second spring and the stem, and wherein the second spring engages the first spring and the plug body.
Embodiment 22. The fire-resistant globe valve of embodiment 21, wherein the first spring is in a mirrored orientation with respect to the second spring.
Embodiment 23. The fire-resistant globe valve of any of embodiments 19-22, wherein the plug body defines a cavity. The stem extends into the cavity. The one or more springs are located in the cavity.
Embodiment 24. The fire-resistant globe valve of embodiment 23, wherein the plug body includes an inner surface that defines the cavity. At least one of the one or more springs engages the inner surface of the plug body.
Embodiment 25. The fire-resistant globe valve of embodiment 24, further including an insert that is coupled to the stem. The inner surface of the plug body further defines a recess that at least partially receives the insert.
Embodiment 26. The fire-resistant globe valve of embodiment 25, wherein the insert extends through the one or more springs to retain the one or more springs in place between the stem and the inner surface of the plug body.
Embodiment 27. The fire-resistant globe valve of any of embodiments 23-26, wherein the stem includes a flange. The plug body includes a lip at a cavity inlet of the cavity. The lip of the plug body is configured to overlap the flange of the stem to connect the plug to the stem.
Embodiment 28. The fire-resistant globe valve of any of embodiments 19-27, wherein the valve seat is composed of metallic material and the seat disc is composed of thermoplastic material such that a thermoplastic-to-metal seal is formed when the seat disc engages the valve seat in the first closed position of the plug.
Embodiment 29. The fire-resistant globe valve of embodiment 28, wherein the plug body is composed of metallic material such that a metal-to-metal seal is formed when the plug body engages the valve seat in the second closed position of the plug.
Embodiment 30. The fire-resistant globe valve of any of embodiments 19-29, wherein the plug body includes an outer rim that at least partially defines a groove in which the seat disc is received. A portion of the seat disc extends beyond a lower end of the outer rim when the seat disc is received by the groove.
Embodiment 31. The fire-resistant globe valve of embodiment 30, wherein the valve seat includes an upper surface and angled surface that extends inwardly and downwardly from the upper surface.
Embodiment 32. The fire-resistant globe valve of embodiment 31, wherein the seat disc is configured to engage the angled surface of the valve seat in the first closed position of the plug. A gap is formed between the lower end of the outer rim of the plug body and the upper surface of the valve seat when the seat disc engages the angled surface in the first closed position of the plug.
Embodiment 33. The fire-resistant globe valve of embodiment 32, wherein, when the seat disc deforms while the plug is in the first closed position, a biasing force of the one or more springs is configured to cause the plug body to close the gap and transition the plug to the second closed position without backpressure and further actuation of the stem. The lower end of the outer rim is configured to engage the upper surface of the valve seat in the second closed position of the plug.
Embodiment 34. The fire-resistant globe valve of any of embodiments 19-33, further including an actuator coupled to the stem to actuate the plug between the first closed position and an open position.
Embodiment 35. The fire-resistant globe valve of embodiment 34, wherein the actuator is a wheel.

What is claimed is:

1. A fire-resistant globe valve, comprising:
a valve body defining an inlet, an outlet, and a flow path extending between the inlet and the outlet;
a valve seat located along the flow path between the inlet and the outlet;
a stem comprising a first end and a second end;
a plug coupled to the second end of the stem, wherein the plug comprises a plug body and a seat disc, wherein the seat disc is coupled to the plug body, and wherein the seat disc is configured to sealingly engage the valve seat in a first closed position of the plug; and
one or more springs positioned between and engaging the second end of the stem and the plug body, wherein the one or more springs are configured to bias the plug body to sealingly engage the valve seat in a second closed position of the plug when the seat disc deforms from exposure to fire conditions.

2. The fire-resistant globe valve of claim 1, wherein each of the one or more springs is a preloaded disc spring.

3. The fire-resistant globe valve of claim 1, wherein the one or more springs includes a first spring and a second spring, wherein the first spring engages the second spring and the second end of the stem, and wherein the second spring engages the first spring and the plug body.

4. The fire-resistant globe valve of claim 3, wherein the first spring is in a mirrored orientation with respect to the second spring.

5. The fire-resistant globe valve of claim 1, wherein the plug body defines a cavity, wherein the second end of the stem extends into the cavity, and wherein the one or more springs are located in the cavity.

6. The fire-resistant globe valve of claim 5, wherein the plug body includes an inner surface that defines the cavity, wherein at least one of the one or more springs engages the inner surface of the plug body.

7. The fire-resistant globe valve of claim 6, further comprising an insert that is coupled to the second end of the stem, wherein the inner surface of the plug body further defines a recess that at least partially receives the insert, and wherein the insert extends through the one or more springs to retain the one or more springs in place between the second end of the stem and the inner surface of the plug body.

8. The fire-resistant globe valve of claim 5, wherein the stem includes a flange at the second end, wherein the plug body includes a lip at a cavity inlet of the cavity, and wherein the lip of the plug body is configured to overlap the flange of the stem to connect the plug to the second end of the stem.

9. The fire-resistant globe valve of claim 1, wherein the valve seat is composed of metallic material and the seat disc is composed of thermoplastic material such that a thermoplastic-to-metal seal is formed when the seat disc engages the valve seat in the first closed position of the plug.

10. The fire-resistant globe valve of claim 9, wherein the plug body is composed of metallic material such that a metal-to-metal seal is formed when the plug body engages the valve seat in the second closed position of the plug.

11. The fire-resistant globe valve of claim 1, wherein the plug body includes an outer rim that at least partially defines a groove in which the seat disc is received, and wherein a portion of the seat disc extends beyond a lower end of the outer rim when the seat disc is received by the groove.

12. The fire-resistant globe valve of claim 11, wherein the valve seat includes an upper surface and angled surface that extends inwardly and downwardly from the upper surface.

13. The fire-resistant globe valve of claim 12, wherein the seat disc is configured to engage the angled surface of the valve seat in the first closed position of the plug, and wherein a gap is formed between the lower end of the outer rim of the plug body and the upper surface of the valve seat when the seat disc engages the angled surface in the first closed position of the plug.

14. The fire-resistant globe valve of claim 13, wherein, when the seat disc deforms while the plug is in the first closed position, a biasing force of the one or more springs is configured to cause the plug body to close the gap and transition the plug to the second closed position without backpressure and further actuation of the stem, and wherein the lower end of the outer rim is configured to engage the upper surface of the valve seat in the second closed position of the plug.

15. The fire-resistant globe valve of claim 1, further comprising an actuator coupled to the first end of the stem to actuate the plug between the first closed position and an open position, wherein the actuator is a wheel.

16. A fire-resistant globe valve, comprising:
a valve seat;
a stem;
a plug coupled to the stem, wherein the plug comprises a plug body and a seat disc, wherein the seat disc is coupled to the plug body, and wherein the seat disc is configured to sealingly engage the valve seat in a first closed position of the plug; and
one or more springs positioned between and engaging the stem and the plug body, wherein the one or more springs are configured to bias the plug body to sealingly engage the valve seat in a second closed position of the plug when the seat disc deforms from exposure to fire conditions.

17. The fire-resistant globe valve of claim 16, wherein the valve seat is composed of metallic material and the seat disc is composed of thermoplastic material such that a thermoplastic-to-metal seal is formed when the seat disc engages the valve seat in the first closed position of the plug, and wherein the plug body is composed of metallic material such that a metal-to-metal seal is formed when the plug body engages the valve seat in the second closed position of the plug.

18. The fire-resistant globe valve of claim 16, wherein the plug body includes an outer rim that at least partially defines a groove in which the seat disc is received, wherein a portion of the seat disc extends beyond a lower end of the outer rim when the seat disc is received by the groove, and wherein the valve seat includes an upper surface and angled surface that extends inwardly and downwardly from the upper surface.

19. The fire-resistant globe valve of claim 18, wherein the seat disc is configured to engage the angled surface of the valve seat in the first closed position of the plug, and wherein a gap is formed between the lower end of the outer rim of the plug body and the upper surface of the valve seat when the seat disc engages the angled surface in the first closed position of the plug.

20. The fire-resistant globe valve of claim 19, wherein, when the seat disc deforms while the plug is in the first closed position, a biasing force of the one or more springs is configured to cause the plug body to close the gap and transition the plug to the second closed position without backpressure and further actuation of the stem, and wherein the lower end of the outer rim is configured to engage the upper surface of the valve seat in the second closed position of the plug.
